(19) United States
(12) Patent Application Publication
(10) Pub. No.: US 2020/0308433 A1
(43) Pub. Date: Oct. 1, 2020

(54) AQUEOUS INK JET COMPOSITION AND METHOD FOR PRODUCING RECORDING

(71) Applicant: Seiko Epson Corporation, Tokyo (JP)

(72) Inventors: Soichi YAMAZAKI, Shiojiri (JP); Naoyuki TOYODA, Suwa (JP); Hiroaki KUMETA, Matsumoto (JP); Manabu TANIGUCHI, Shiojiri (JP); Shunsuke UCHIZONO, Shiojiri (JP)

(21) Appl. No.: 16/832,195

(22) Filed: Mar. 27, 2020

(30) Foreign Application Priority Data
Mar. 28, 2019 (JP) 2019-062582

(51) Int. Cl. C09D 11/328; C09D 11/104; B41M 5/00; B41J 11/00

(52) U.S. Cl. CPC C09D 11/328; B41J 11/002; B41M 5/0023; C09D 11/104

(57) ABSTRACT

An aqueous ink jet composition contains water, a dye composed of at least one of sublimation dyes or at least one of disperse dyes, polyester, and a urethane resin. Preferably, 4.0≤X_{E}/X_{D}≤300, where X_{D} is the amount of the dye in the aqueous ink jet composition (% by mass), and X_{E} is the amount of the polyester in the aqueous ink jet composition (% by mass).

The present application is based on, and claims priority from JP Application Serial Number 2019-062582, filed Mar. 28, 2019, the disclosure of which is hereby incorporated by reference herein in its entirety.

### BACKGROUND

### 1. Technical Field

The present disclosure relates to an aqueous ink jet composition and a method for producing a recording.

### 2. Related Art

In recent years, ink jet printing is becoming more widely used. Besides business and home printers, the technology is now applied to areas such as commercial printing and textile printing.

Against this background, certain types of inks currently used for ink jet printing contain a sublimation dye, i.e., a dye that can sublime, or a disperse dye.

Examples of printing processes in which such ink jet inks are used include direct printing, in which inks are attached to the recording medium to be dyed and then the dyes are fixed by heating, such as steaming, and thermal-transfer printing, in which dye inks are attached to an intermediate transfer medium and then heat is applied to transfer, by sublimation, the dyes from the intermediate transfer medium to the recording medium to be dyed (e.g., see JP-A-10-58638).

Producing strong colors in such settings requires a polyester surface on the recording medium, and this has limited the range of recording media that can be used. Increasing the heating temperature can improve the strength of the colors produced by the sublimation or disperse dyes, but depending on the type of recording medium, it can cause an unwanted discoloration, for example by causing the recording medium itself to melt or scorch. Another disadvantage in the related art is that the print formed is poor in terms of feel and texture.

### SUMMARY

The present disclosure was made to solve the above problem and can be implemented as in the following exemplary applications.

An aqueous ink jet composition according to an exemplary application of the present disclosure contains water, a dye composed of at least one of sublimation dyes or at least one of disperse dyes, polyester, and a urethane resin.

An aqueous ink jet composition according to another exemplary application of the present disclosure further contains an oxazoline-containing polymer.

In an aqueous ink jet composition according to another exemplary application of the present disclosure, the amount of the dye in the aqueous ink jet composition is 0.1% by mass or more and 3.0% by mass or less.

In an aqueous ink jet composition according to another exemplary application of the present disclosure, the amount of the polyester in the aqueous ink jet composition is 5% by mass or more and 30% by mass or less.

In an aqueous ink jet composition according to another exemplary application of the present disclosure, the amount of the urethane resin in the aqueous ink jet composition is 2.5% by mass or more and 15% by mass or less.

In an aqueous ink jet composition according to another exemplary application of the present disclosure, 4.0X_{E}/X_{D}≤300, where X_{D} is the amount of the dye in the aqueous ink jet composition in % by mass, and X_{E} is the amount of the polyester in the aqueous ink jet composition in % by mass.

In an aqueous ink jet composition according to another exemplary application of the present disclosure, 2.0≤X_{U}/X_{D}≤150, where X_{D} is the amount of the dye in the aqueous ink jet composition in % by mass, and X_{U} is the amount of the urethane resin in the aqueous ink jet composition in % by mass.

In an aqueous ink jet composition according to another exemplary application of the present disclosure, 1.5≤X_{E}/X_{U}≤5.0, where X_{E} is the amount of the polyester in the aqueous ink jet composition in % by mass, and X_{U} is the amount of the urethane resin in the aqueous ink jet composition in % by mass.

In an aqueous ink jet composition according to another exemplary application of the present disclosure, the glass transition temperature of the polyester is 0° C. or more and 90° C. or less.

In an aqueous ink jet composition according to another exemplary application of the present disclosure, the dye is one or two or more selected from the group consisting of C.I. Disperse Yellow 54, C.I. Disperse Red 60, C.I. Disperse Blue 360, C.I. Disperse Blue 359, C.I. Disperse Orange 25, C.I. Disperse Orange 60, C.I. Disperse Red 364, and C.I. Disperse Yellow 232.

A method according to an exemplary application of the present disclosure for producing a recording includes an attachment step, in which an aqueous ink jet composition according to an exemplary application of the present disclosure is ejected by ink jet technology and attached to a recording medium; and a heating step, in which the recording medium with the aqueous ink jet composition attached thereto is heated.

In a method according to another exemplary application of the present disclosure for producing a recording, the recording medium is a piece of fabric.

In a method according to another exemplary application of the present disclosure for producing a recording, the recording medium is made of at least one material including one or two or more selected from the group consisting of silk, wool, cellulose, acrylic fiber, polyurethane, and polyamide.

In a method according to another exemplary application of the present disclosure for producing a recording, the recording medium is made of materials including polyester and one or two or more selected from the group consisting of cotton, silk, polyamide, acrylic fiber, and polyurethane.

In a method according to another exemplary application of the present disclosure for producing a recording, the temperature at which the recording medium is heated in the heating step is 100° C. or more and 160° C. or less.

### DESCRIPTION OF EXEMPLARY EMBODIMENTS

The following describes preferred embodiments of the present disclosure in detail.

### 1. Aqueous Ink Jet Composition

First, an aqueous ink jet composition according to a preferred embodiment of the present disclosure is described.

The aqueous ink jet composition according to a preferred embodiment of the present disclosure contains water, a dye composed of at least one of sublimation dyes or at least one of disperse dyes, polyester, and a urethane resin.

By satisfying these conditions, the aqueous ink jet composition produces a strong color with a wide variety of recording media and gives good feel and texture to the print it forms on a recording medium. Of particular note is that a print of good feel and texture is formed on a recording medium and is fixed well to the recording medium by virtue of the presence of polyester and a urethane resin besides the dye. Examples of elements of feel and texture that are improved include smoothness, flexibility, and softness. When the recording medium is a piece of fabric or any other sheet-shaped material, the crease resistance of the recording, or more specifically that when the recording is washed, is also improved. Furthermore, the composition produces a strong color even when the recording medium is heated at a relatively low temperature for a relatively short period of time. By virtue of being capable of producing a strong color even when the recording medium is heated at a relatively low temperature for a relatively short period of time, the composition is suitable even for use with recording media vulnerable to heat, such as those made of a material that melts or undergoes an unwanted discoloration upon heating at a relatively low temperature, providing more flexibility in the selection of the recording medium. By virtue of being capable of producing a strong color even when the recording medium is heated at a relatively low temperature for a relatively short period of time, the composition is also advantageous in terms of energy conservation and improving productivity in manufacturing recordings. The aqueous ink jet composition according to a preferred embodiment of the present disclosure, moreover, can be used in methods for producing a recording in which no transfer is involved (described in detail later herein) and therefore is also favorable in terms of, for example, improving productivity in manufacturing recordings, reducing the cost of producing recordings, and resource conservation. Besides these, the composition is efficient in color production by the dye. Even when its dye content is low, therefore, the aqueous ink jet composition gives recordings produced therewith a sufficiently high color density.

The inventors believe these great advantages owe to the following reason. That is, whereas heating a sublimation or disperse dye causes it to sublime or diffuse, heating polyester causes it to decompose. Polyester has ester linkages in its backbone, and when it is heated, some of the ester linkages break into carboxyl groups and hydroxyl groups. When the polyester is cooled, the carboxyl and hydroxyl groups recombine together. Heating polyester and at least one of sublimation or disperse dyes present close together and then cooling them therefore causes the sublimation or disperse dye to sublime or diffuse as single molecules and then keep its single-molecule state inside the polyester. As a result, the inventors believe, a strong color is produced. Furthermore, since the sublimation or disperse dye becomes single molecules even when its distance of travel is short compared with that in the known transfer by sublimation, the color produced is sufficiently strong even with a relatively short heating at a relatively low temperature.

It should be noted that sublimation and disperse dyes produce strong colors by becoming single molecules. Aggregates of molecules are poor in color strength compared with single molecules, however high the dye content is.

In addition, the use of polyester in combination with a urethane resin, which is highly compatible with polyester, helps ensure good feel and texture of the print the composition forms on a recording medium while ensuring good fixation of the print to the recording medium.

When the above conditions are not satisfied, the results are unsatisfactory.

For example, with a polyester-free aqueous ink jet composition, it would be difficult to increase the percentage of single molecules in all molecules of the sublimation or disperse dye sufficiently high except with a recording medium having a polyester surface. The color strength would therefore unsatisfactory.

With an aqueous ink composition that contains no urethane resin, the feel and texture of the print on recordings produced using the aqueous ink jet composition would be degraded significantly. The fixation of the print to the recording medium would also be worse.

It should be noted that an aqueous ink jet composition herein refers not only to ink itself ejected by ink jet technology but also to undiluted solution from which the ink is prepared. In other words, an aqueous ink jet composition according to a preferred embodiment of the present disclosure may be ejected by ink jet technology directly or may be ejected by ink jet technology after dilution or any such treatment. An aqueous ink jet composition herein, moreover, contains at least water as a major volatile liquid component. The proportion of water to all volatile liquid components in the aqueous ink jet composition is preferably 40% by mass or more, more preferably 50% by mass or more, even more preferably 70% by mass or more.

### 1-1 Specific Dye

The aqueous ink jet composition according to a preferred embodiment of the present disclosure contains a dye composed of at least one of sublimation dyes or at least one of disperse dyes. Sublimation dyes and disperse dyes may hereinafter be collectively referred to as “specific dyes.”

In general, specific dyes produce strong colors when used with polyester. However, when used with other types of recording media, such as those made of materials like wool, cellulose, cotton, silk, polyester, polyamide, acrylic fiber, and polyurethane, specific dyes only produce weaker colors.

Examples of sublimation or disperse dyes include C.I. Disperse Yellow 1, 3, 4, 5, 7, 9, 13, 23, 24, 30, 33, 34, 42, 44, 49, 50, 51, 54, 56, 58, 60, 61, 63, 64, 66, 68, 71, 74, 76, 79, 82, 83, 85, 86, 88, 90, 91, 93, 98, 99, 100, 104, 108, 114, 116, 118, 119, 122, 124, 126, 135, 140, 141, 149, 154, 160, 162, 163, 164, 165, 179, 180, 182, 183, 184, 186, 192, 198, 199, 201, 202, 204, 210, 211, 215, 216, 218, 224, 227, 231, and 232; C.I. Disperse Orange 1, 3, 5, 7, 11, 13, 17, 20, 21, 25, 29, 30, 31, 32, 33, 37, 38, 42, 43, 44, 45, 46, 47, 48, 49, 50, 53, 54, 55, 56, 57, 58, 59, 60, 61, 66, 71, 73, 76, 78, 80, 89, 90, 91, 93, 96, 97, 119, 127, 130, 139, and 142; C.I. Disperse Red 1, 4, 5, 7, 11, 12, 13, 15, 17, 27, 43, 44, 50, 52, 53, 54, 55, 56, 58, 59, 60, 65, 72, 73, 74, 75, 76, 78, 81, 82, 86, 88, 90, 91, 92, 93, 96, 103, 105, 106, 107, 108, 110, 111, 113, 117, 118, 121, 122, 126, 127, 128, 131, 132, 134, 135, 137, 143, 145, 146, 151, 152, 153, 154, 157, 159, 164, 167, 169, 177, 179, 181, 183, 184, 185, 188, 189, 190, 191, 192, 200, 201, 202, 203, 205, 206, 207, 210, 221, 224, 225, 227, 229, 239, 240, 257, 258, 277, 278, 279, 281, 288, 298, 302, 303, 310, 311, 312, 320, 324, 328, and 364; C.I. Disperse Violet 1, 4, 8, 23, 26, 27, 28, 31, 33, 35, 36, 38, 40, 43, 46, 48, 50, 51, 52, 56, 57, 59, 61, 63, 69, and 77; C.I. Disperse Green 9; C.I. Disperse Brown 1, 2, 4, 9, 13, and 19; C.I. Disperse Blue 3, 7, 9, 14, 16, 19, 20, 24, 26, 27, 35, 43, 44, 54, 55, 56, 58, 60, 62, 64, 71, 72, 73, 75, 79, 81, 82, 83, 87, 91, 92, 93, 94, 95, 96, 102, 106, 108, 112, 113, 115, 118, 120, 122, 125, 128, 130, 139, 141, 142, 143, 146, 148, 149, 153, 154, 158, 165, 167, 171, 173, 174, 176, 181, 183, 185, 186, 187, 189, 197, 198, 200, 201, 205, 207, 211, 214, 224, 225, 257, 259, 267, 268, 270, 284, 285, 287, 288, 291, 293, 295, 297, 301, 315, 330, 333, 359, and 360; C.I. Disperse Black 1, 3, 10, and 24.

Examples of sublimation or disperse fluorescent dyes include C.I. Disperse Red 364, C.I. Disperse Red 362, C.I. Vat Red 41, C.I. Disperse Yellow 232, C.I. Disperse Yellow 184, C.I. Disperse Yellow 82, and C.I. Disperse Yellow 43.

The specific dye may be one such sublimation or disperse dye or may be a combination of two or more.

It is particularly preferred that the specific dye be one or two or more selected from the group consisting of C.I. Disperse Yellow 54, C.I. Disperse Red 60, C.I. Disperse Blue 360, C.I. Disperse Blue 359, C.I. Disperse Orange 25, C.I. Disperse Orange 60, C.I. Disperse Red 364, and C.I. Disperse Yellow 232.

This helps make the color strength of the print on a recording even stronger. The strength of the color, moreover, will be sufficient even with heating for a shorter duration at a lower temperature.

The lower limit to the specific dye content of the aqueous ink jet composition is preferably 0.1% by mass, more preferably 0.15% by mass, even more preferably 0.2% by mass. The upper limit to the specific dye content of the aqueous ink jet composition is preferably 7.5% by mass, more preferably 3.0% by mass, even more preferably 2.4% by mass.

This helps make the color strength and optical density of the print on a recording produced using the aqueous ink jet composition even better. Events like unwanted color irregularities in the recording, moreover, will be prevented more effectively.

### 1-2 Polyester

The aqueous ink jet composition according to a preferred embodiment of the present disclosure contains polyester.

In general, polyesters can be dyed well with specific dyes as defined above.

The polyester can be, for example, polyethylene terephthalate, polybutylene terephthalate, polytrimethylene terephthalate, polyethylene naphthalate, or polybutylene naphthalate.

The polyester can be any polymer material that has the ester linkage in its backbone. Thus, the polyester may be, for example, a modified polyester.

Examples of commercially available polyesters that can be used to prepare the aqueous ink jet composition according to a preferred embodiment of the present disclosure include The Nippon Synthetic Chemical's POLYESTER, GOO Chemical's PLAS COAT, Toagosei's ARON MELT, Unitika's elitel, Takamatsu Oil & Fat's PESRESIN, DKS's SUPERFLEX, Toyobo's Vylonal, and Tosoh's NIPPOLAN polyester polyols. When a commercially available aqueous dispersion of polyester is used, the polyester content is adjusted so that the polyester content on a solids basis will satisfy the relation specified later.

The lower limit to the acid value of the polyester as a component of the aqueous ink jet composition according to a preferred embodiment of the present disclosure is preferably 1.0 KOH mg/g, more preferably 1.5 KOH mg/g, even more preferably 2.0 KOH mg/g. The upper limit to the acid value of the polyester as a component of the aqueous ink jet composition according to a preferred embodiment of the present disclosure is preferably 15 KOH mg/g, more preferably 10 KOH mg/g, even more preferably 5.0 KOH mg/g.

This helps ensure the specific dye will produce an even stronger color with a wide variety of recording media.

The lower limit to the hydroxyl value of the polyester as a component of the aqueous ink jet composition according to a preferred embodiment of the present disclosure is preferably 1.0 KOH mg/g, more preferably 2.0

KOH mg/g, even more preferably 3.0 KOH mg/g. The upper limit to the hydroxyl value of the polyester as a component of the aqueous ink jet composition according to a preferred embodiment of the present disclosure is preferably 20 KOH mg/g, more preferably 15 KOH mg/g, even more preferably 10 KOH mg/g.

This helps ensure the specific dye will produce an even stronger color with a wide variety of recording media.

The lower limit to the number-average molecular weight of the polyester as a component of the aqueous ink jet composition according to a preferred embodiment of the present disclosure is preferably 3000, more preferably 6000, even more preferably 10000. The upper limit to the number-average molecular weight of the polyester as a component of the aqueous ink jet composition according to a preferred embodiment of the present disclosure is preferably 25000, more preferably 20000, even more preferably 18000.

This helps ensure the specific dye will produce an even stronger color with a wide variety of recording media.

The lower limit to the glass transition temperature of the polyester is preferably 0° C., more preferably 25° C., even more preferably 40° C. The upper limit to the glass transition temperature of the polyester is preferably 90° C., more preferably 75° C., even more preferably 70° C.

This helps combine higher levels of fixation of the polyester to a recording medium and durability of a recording produced using the aqueous ink jet composition.

The polyester may be in any form in the aqueous ink jet composition. For example, the polyester may be present dissolved or may be present dispersed (including situations in which the polyester forms a colloid or emulsion) in the aqueous ink jet composition. The polyester may alternatively be present forming a gel. The polyester may cover at least part of the surface of the specific dye and/or urethane resin in the aqueous ink jet composition. These states can coexist.

When the aqueous ink jet composition contains the polyester in particulate form, the lower limit to the average particle diameter of the polyester is preferably 20 nm, more preferably 40 nm, even more preferably 60 nm. The upper limit to the average particle diameter of the polyester is preferably 300 nm, more preferably 250 nm, even more preferably 200 nm.

This makes it easier to prepare the aqueous ink jet composition. The stability of the polyester dispersed in the aqueous ink jet composition will also be bettered, and so will be the storage stability of the aqueous ink jet composition and the stability of the aqueous ink jet composition upon ink jet ejection. After the aqueous ink jet composition is attached to a recording medium, moreover, single molecules of the specific dye will adsorb better. As a result, the color produced by the specific dye will be even stronger.

An average diameter of particles herein refers to the volume-average diameter of the particles unless stated otherwise. The average diameter of particles can be determined by, for example, measurement using Microtrac UPA (Nikkiso).

The lower limit to the polyester content of the aqueous ink jet composition is preferably 2% by mass, more preferably 5% by mass, even more preferably 10% by mass. The upper limit to the polyester content of the aqueous ink jet composition is preferably 40% by mass, more preferably 30% by mass, even more preferably 20% by mass.

This helps better the storage stability of the aqueous ink jet composition and the stability of the aqueous ink jet composition upon ink jet ejection. The fixation of the print on a recording produced using the aqueous ink jet composition and the durability of the recording, moreover, will be even better.

The lower limit to X_{E}/X_{D}, where X_{D} is the specific dye content of the aqueous ink jet composition (% by mass), and X_{E} is the polyester content of the aqueous ink jet composition (% by mass), is preferably 4.0, more preferably 10, even more preferably 30. The upper limit to X_{E}/X_{D} is preferably 300, more preferably 150, even more preferably 60.

This helps combine higher levels of color strength of the print formed using the aqueous ink jet composition, adhesion of the print to the recording medium on a recording, and durability of the recording.

### 1-3 Urethane Resin

The aqueous ink jet composition according to a preferred embodiment of the present disclosure contains a urethane resin.

In general, urethane resins are highly flexible and highly compatible with polyesters.

The urethane resin can be any polymer that has the urethane linkage in the molecule.

Examples of commercially available urethane resins that can be used to prepare the aqueous ink jet composition according to a preferred embodiment of the present disclosure include Ube Industries' UW1527F, Mitsui Chemicals Polyurethanes' TAKELAC W-6061, Sumika Bayer Urethane's Desmodur W, and DIC's HYDRAN AP-40F polyurethane dispersion.

The lower limit to the number-average molecular weight of the urethane resin as a component of the aqueous ink jet composition according to a preferred embodiment of the present disclosure is preferably 1000, more preferably 3000, even more preferably 6000. The upper limit to the number-average molecular weight of the urethane resin as a component of the aqueous ink jet composition according to a preferred embodiment of the present disclosure is preferably 30000, more preferably 20000, even more preferably 10000.

This helps make the compatibility between the urethane resin and the polyester even better, thereby helping improve the feel and texture, water resistance, resistance to solvents, thermal resistance, film strength, etc., of the print on a recording produced using the aqueous ink jet composition.

The lower limit to the glass transition temperature of the urethane resin is preferably −80° C., more preferably −70° C., even more preferably −60° C. The upper limit to the glass transition temperature of the urethane resin is preferably 20° C., more preferably 10° C., even more preferably 0° C.

This helps make the compatibility between the urethane resin and the polyester even better and also helps improve characteristics, such as feel and texture, water resistance, resistance to solvents, thermal resistance, and film strength, of the print on a recording produced using the aqueous ink jet composition.

The urethane resin may be in any form in the aqueous ink jet composition. For example, the urethane resin may be present dissolved or may be part of a colloid, part of an emulsion, or otherwise dispersed in the aqueous ink jet composition. The urethane resin may alternatively be present forming a gel. The urethane resin may cover at least part of the surface of the specific dye and/or polyester in the aqueous ink jet composition. These states can coexist.

The lower limit to the urethane resin content of the aqueous ink jet composition is preferably 2.5% by mass, more preferably 3% by mass, even more preferably 3.5% by mass. The upper limit to the urethane resin content of the aqueous ink jet composition is preferably 15% by mass, more preferably 12% by mass, even more preferably 10% by mass.

This helps ensure the durability, color strength, etc., of a recording produced using the aqueous ink jet composition will be sufficiently good while making the feel and texture, for example, of the print on the recording even better. The storage stability of the aqueous ink jet composition and the stability of the aqueous ink jet composition upon ink jet ejection will also be bettered.

The lower limit to X_{U}/X_{D}, where X_{D} is the specific dye content of the aqueous ink jet composition (% by mass), and X_{U} is the urethane resin content of the aqueous ink jet composition (% by mass), is preferably 2.0, more preferably 4.0, even more preferably 6.0. The upper limit to X_{U}/X_{D} is preferably 150, more preferably 100, even more preferably 30.

This helps combine higher levels of color strength and feel and texture of the print formed using the aqueous ink jet composition.

The lower limit to X_{E}/X_{U}, where X_{E} is the polyester content of the aqueous ink jet composition (% by mass), and X_{U} is the urethane resin content of the aqueous ink jet composition (% by mass), is preferably 1.5, more preferably 1.6, even more preferably 1.7. The upper limit to X_{E}/X_{U} is preferably 5.0, more preferably 4.7, even more preferably 4.3.

This helps combine higher levels of color strength and feel and texture of the print formed using the aqueous ink jet composition.

### 1-4 Water

The aqueous ink jet composition contains water. The primary function of the water is to give the aqueous ink jet composition fluidity, and the water functions as a solvent or dispersing medium for ingredients such as the polyester and urethane resin described above.

The water may be, for example, reverse osmosis (RO) water, distilled water, ion exchange water, or any other type of purified water.

The lower limit to the water content of the aqueous ink jet composition is not critical, but preferably is 30% by mass, more preferably 35% by mass, even more preferably 40% by mass. The upper limit to the water content of the aqueous ink jet composition is not critical, but preferably is 85% by mass, more preferably 80% by mass, even more preferably 75% by mass.

This makes it more certain that the viscosity of the aqueous ink jet composition is adjusted to an appropriate level, thereby helping further improve the stability of the composition upon ink jet ejection.

### 1-5 Nonaqueous Solvent

The aqueous ink jet composition may contain a nonaqueous solvent.

This helps adjust the viscosity of the aqueous ink jet composition to an appropriate level and also helps improve the water retention of the aqueous ink jet composition. As a result, ink jet ejection of droplets of the composition will be more stable.

Examples of nonaqueous solvents that can be contained in the aqueous ink jet composition include glycerol, propylene glycol, and 2-pyrrolidone.

These solvents slow down the evaporation of the composition with their excellent water retention potential, thereby enabling more stable ejection of droplets of the composition.

The lower limit to the nonaqueous solvent content of the aqueous ink jet composition is not critical, but preferably is 0% by mass, more preferably 3% by mass, even more preferably 5% by mass. The upper limit to the nonaqueous solvent content of the aqueous ink jet composition is not critical, but preferably is 30% by mass, more preferably 25% by mass, even more preferably 20% by mass.

This makes the aforementioned effects of the presence of a nonaqueous solvent more significant.

### 1-6 Oxazoline-Containing Polymer

The aqueous ink jet composition may further contain a polymer that contains an oxazoline group.

The oxazoline-containing polymer functions as a curing agent for the urethane resin. The film strength of the print formed by the aqueous ink jet composition will therefore be even better, and so will be the durability of the recording. At the same time, the feel and texture of the print will be sufficiently good.

An example of a suitable oxazoline-containing polymer is one having a backbone composed of acrylic or styrene monomers.

The oxazoline-containing polymer, moreover, can be a water-soluble polymer or water-dispersible polymer, such as an emulsifying polymer.

Examples of commercially available oxazoline-containing polymers that can be used to prepare the aqueous ink jet composition according to a preferred embodiment of the present disclosure include Nippon Shokubai's EPOCROS, SIGMA-ALDRICH's polyoxazolines, and Kao's Elastomer OS.

The lower limit to the oxazoline-containing polymer content of the aqueous ink jet composition is preferably 0.1% by mass, more preferably 0.2% by mass, even more preferably 0.3% by mass. The upper limit to the oxazoline-containing polymer content of the aqueous ink jet composition is preferably 3.0% by mass, more preferably 2.5% by mass, even more preferably 2.0% by mass.

This helps combine higher levels of feel and texture of the print formed by the aqueous ink jet composition, film strength of the print, and the durability of the recording.

The lower limit to X_{O}/X_{U}, where X_{O} is the oxazoline-containing polymer content of the aqueous ink jet composition (% by mass), and X_{U} is the urethane resin content of the aqueous ink jet composition (% by mass), is preferably 0.01, more preferably 0.03, even more preferably 0.05. The upper limit to X_{O}/X_{U} is preferably 0.6, more preferably 0.5, even more preferably 0.3.

This helps combine higher levels of color strength of the print formed by the aqueous ink jet composition, feel and texture and film strength of the print, and the durability of the recording.

### 1-7 Extra Ingredients

The aqueous ink jet composition may contain ingredients other than those described above. Such ingredients may hereinafter be referred to as extra ingredients.

Examples of extra ingredients include colorants other than specific dyes; resin materials other than polyesters and urethane resins; surfactants; dispersants; emulsifiers; penetrants, such as triethylene glycol monomethyl ether, triethylene glycol monobutyl ether, diethylene glycol monomethyl ether, 1,2-hexanediol, 1,2-pentanediol, 1,2-butanediol, and 3-methyl-1,5-pentanediol; drying retarders, such as triethanolamine; pH-adjusting agents; chelating agents, such as ethylenediaminetetraacetate; antimolds/preservatives; and antirusts. Compounds having an isothiazolinone structure in the molecule, for example, are suitable for use as antimolds/preservatives.

In particular, the presence of a surfactant in the aqueous ink jet composition is advantageous in achieving better image quality. The surfactant will help improve the wettability of the aqueous ink jet composition on a recording medium.

A surfactant in the aqueous ink jet composition can be selected from various surfactants, including anionic surfactants, cationic surfactants, and nonionic surfactants.

More specifically, examples of surfactants that can be contained in the aqueous ink jet composition include acetylene surfactants, silicone surfactants, and fluorosurfactants.

The extra ingredient content of the aqueous ink jet composition is preferably 6% by mass or less, more preferably 5% by mass or less. When multiple extra ingredients are contained, it is preferred that the total amount satisfy this.

The lower limit to the surface tension at 25° C. of the aqueous ink jet composition is not critical, but preferably is 20 mN/m, more preferably 21 mN/m, even more preferably 23 mN/m. The upper limit to the surface tension at 25° C. of the aqueous ink jet composition is not critical, but preferably is 50 mN/m, more preferably 40 mN/m, even more preferably 30 mN/m.

This makes it less likely that, for example, the composition will clog the nozzles of an ink jet ejection apparatus used therewith, thereby further improving the stability of the aqueous ink jet composition upon ejection. The nozzles, moreover, will recover more quickly after capping even when clogged.

The surface tension can be that measured by the Wilhelmy method. The measurement of the surface tension can be through the use of a surface tensiometer, such as Kyowa Interface Science CBVP-7.

The lower limit to the viscosity at 25° C. of the aqueous ink jet composition is not critical, but preferably is 2 mPa·s, more preferably 3 mPa·s, even more preferably 4 mPa·s. The upper limit to the viscosity at 25° C. of the aqueous ink jet composition is not critical, but preferably is 30 mPa·s, more preferably 20 mPa·s, even more preferably 10 mPa·s.

This further improves the stability of the aqueous ink jet composition upon ejection.

The viscosity can be measured using a rheometer, such as Physica MCR-300. With such a rheometer, the shear rate is increased from 10 [s¹] to 1000 [s¹] at 25° C., and the viscosity is read at a shear rate of 200.

When the aqueous ink jet composition according to a preferred embodiment of the present disclosure is ink, the ink is usually packed in a container, such as a cartridge, bag, or tank, and used in that state with an ink jet recording apparatus. In other words, a recording apparatus according to a preferred embodiment of the present disclosure is one that includes an ink cartridge or other container in which ink as an aqueous ink jet composition according to a preferred embodiment has been packed.

### 2. Method for Producing a Recording

The following describes a method according to a preferred embodiment of the present disclosure for producing a recording.

A method according to a preferred embodiment of the present disclosure for producing a recording includes an attachment step, in which an aqueous ink jet composition according to a preferred embodiment of the present disclosure as described above is ejected by ink jet technology and attached to a recording medium; and a heating step, in which the recording medium with the aqueous ink jet composition attached thereto is heated.

The recording produced by this method has a print superior in color strength and feel and texture. Of particular note is that the print formed is superior in color strength and feel and texture with a wide variety of recording media.

### 2-1 Attachment Step

In the attachment step, an aqueous ink jet composition is ejected by ink jet technology and attached to a recording medium. The ink jet ejection of the aqueous ink jet composition can be through the use of a known ink jet recording apparatus. Examples of ejection techniques include piezoelectric ejection and the use of bubbles resulting from heating ink. Piezoelectric ejection is particularly preferred, for example because it is less detrimental to the quality of the aqueous ink jet composition.

In the attachment step, multiple aqueous ink jet compositions according to a preferred embodiment of the present disclosure may be used in combination. More specifically, multiple aqueous ink jet compositions containing different kinds of specific dyes, for example, may be used in combination.

In the attachment step, moreover, it is possible to use inks other than the aqueous ink jet composition(s) according to a preferred embodiment of the present disclosure.

### 2-2 Recording Medium

The recording medium can be made of any material or materials. Examples include resin materials, such as polyurethane, polyethylene, polypropylene, polyester, polyamide, and acrylic resin; paper, glass, metal, ceramic, leather, wood, and pottery clay and fiber of at least one of them; and natural, synthetic, or semisynthetic fibers, such as silk, animal-based fibers, cotton, hemp (including similar plant-based fibers), polyester, polyamide (nylon), acrylic fiber, polyurethane, cellulose, linters, viscose rayon, cuprammonium rayon, and cellulose acetate, and one or a combination of two or more selected from these can be used. The recording medium can have any three-dimensional shape, such as a sheet, spherical, or cubic shape.

It is particularly preferred that the recording medium be a piece of fabric.

Fabric dyeing is in great demand, for example in the manufacture of printed T-shirts. Printing using an iron or similar tool is widespread, and there is a strong need for dyeing of fabrics other than polyester fiber fabric. A recording produced by forming a print on a piece of such a fabric, furthermore, needs to have smoothness, flexibility, and softness among other qualities of feel and texture and should not crease easily when washed. This preferred embodiment of the present disclosure helps meet these needs. Given these, the advantages of this preferred embodiment of the present disclosure are more significant when the recording medium is a piece of fabric.

Preferably, the recording medium is made of at least one material including one or two or more selected from the group consisting of silk, wool, cellulose, acrylic fiber, polyurethane, and polyamide.

Despite a strong need for dyeing of them, these materials have been unsuitable for dyeing with sublimation or disperse dyes, for example because of their maximum withstand temperature. In this preferred embodiment of the present disclosure, a good recording can be produced even with a recording medium made with any of these materials. Articles made with any such material, furthermore, often need to have good feel and texture. Given these, the advantages of this preferred embodiment of the present disclosure are more significant when the recording medium is made of at least one material including one or two or more selected from the group consisting of silk, wool, cellulose, acrylic fiber, polyurethane, and polyamide.

Fibers used in fabrics include hemp and animal-based fibers (e.g., wool). Being shaggy, hemp and animal-based fibers tend to interfere with ink ejection from nozzles by touching the ink jet head. Even if all nozzles successfully eject the ink, the ink does not adhere firmly because of many microscopic pores and irregularities present in the fabric. Hemp and animal-based fibers are therefore not appropriate for ink jet printing. Cotton, silk, polyester, polyamide, acrylic fiber, and polyurethane, which are not shaggy, are suitable for ink jet printing.

It is therefore preferred that the recording medium be made of at least one material including one or two or more selected from the group consisting of cotton, silk, polyester, polyamide, acrylic fiber, and polyurethane.

Certain recording media may be made of a mixture of polyester and any of these materials, i.e., made of materials including polyester and one or two or more selected from the group consisting of cotton, silk, polyamide, acrylic fiber, and polyurethane. With such a recording medium, known processes of dyeing with sublimation or disperse dye(s) have failed to dye the fiber(s) other than polyester, i.e., have tended to result in uneven dyeing. In this preferred embodiment of the present disclosure, even such a mixture dyes sufficiently well. The advantages of this preferred embodiment of the present disclosure are therefore more significant when the recording medium is such a mixture.

Even polyester alone, moreover, dyes better in this preferred embodiment of the present disclosure than in known processes of dyeing with sublimation or disperse dye(s) by virtue of highly efficient color production.

In the related art, a problem is that it is difficult to ensure sufficiently high color strength of the dye print and sufficiently firm adhesion between the recording medium and the dye print, and this problem looms larger when the recording medium is a piece of paper, glass, ceramic, metal, wood, or resin film or any other dense resin material, especially the recording medium is a piece of glass. In this preferred embodiment of the present disclosure, the color strength of the dye print is sufficiently high, and the adhesion between the recording medium and the dye print is sufficiently firm even with any such recording medium. The advantages of the preferred embodiment of the present disclosure are therefore more significant when the recording medium is a piece of paper, glass, ceramic, metal, wood, or resin film or any other dense resin material.

### 2-3 Heating Step

Then the recording medium with the aqueous ink jet composition attached thereto is heated. As a result, the specific dye is fixed to the recording medium together with the polyester and any other remaining ingredient. The specific dye produces its color well, giving a recording. When the urethane resin is thermosetting, moreover, the curing of the urethane resin proceeds well, making the water resistance, resistance to solvents, thermal resistance, film strength, etc., of the print on the recording produced using the aqueous ink jet composition even better.

The lower limit to the heating temperature in this step is not critical, but preferably is 100° C., more preferably 105° C., even more preferably 110° C. The upper limit to the heating temperature in this step is not critical, but preferably is 180° C., more preferably 160° C., even more preferably 150° C.

This helps further reduce the amount of energy required to produce the recording, thereby helping further improve productivity in manufacturing recordings. The color strength of the resulting recording, moreover, will be further improved. Moreover, even recording media relatively vulnerable to heat are suitable for use, providing further flexibility in the selection of the recording medium. Furthermore, even when the produced recording is heated, for example by laundering or washing with warm water, heat drying in a dryer, or ironing, events like a unwanted discoloration and a change in optical density are well prevented. A heating temperature in any such range in this step also leads to more effective prevention of a loss of feel and texture of the print.

The duration of heating in this step may vary with the heating temperature, but the lower limit to the duration of heating in this step is preferably 0.2 seconds, more preferably 1 second, even more preferably 5 seconds. The upper limit to the duration of heating in this step is preferably 300 seconds, more preferably 60 seconds, even more preferably 30 seconds.

This helps further reduce the amount of energy required to produce the recording, thereby helping further improve productivity in manufacturing recordings. The color strength of the resulting recording, moreover, will be further improved. Moreover, even recording media relatively vulnerable to heat are suitable for use, providing further flexibility in the selection of the recording medium. A duration of heating in any such range in this step also leads to more effective prevention of a loss of feel and texture of the print.

This step may be performed by heating the surface of the recording medium to which the aqueous ink jet composition has been attached with this surface spaced apart from the heater or may be performed by heating this surface with the recording medium with the aqueous ink jet composition attached thereto and the heater in close contact with each other. Preferably, this step is performed by heating the surface of the recording medium to which the aqueous ink jet composition has been attached with the recording medium and the heater in close contact with each other.

This helps further reduce the amount of energy required to produce the recording, thereby helping further improve productivity in manufacturing recordings. The color strength of the resulting recording, moreover, will be further improved. Moreover, diffusion of the specific dye from the recording medium will be prevented more effectively. A loss of feel and texture of the print is also prevented more effectively.

It is to be understood that the foregoing is a description of preferred embodiments of the present disclosure, and no aspect of the present disclosure is limited to them.

For example, an aqueous ink jet composition according to a preferred embodiment of the present disclosure is to be ejected by ink jet technology, but its use is not limited to methods like that described above.

For example, the composition may be used in a method that includes extra operations besides the steps described above.

When this is the case, a pretreatment can be, for example, forming a coating layer on the recording medium.

An intermediate treatment can be, for example, preheating the recording medium.

A post-treatment can be, for example, washing the recording medium.

### EXAMPLES

The following describes specific examples of aspects of the present disclosure.

### 1. Preparation of Ink Jet Inks

### Example 1

First, C.I. Disperse Yellow 54 as a specific dye was mixed with MD-1480 (Toyobo) as an aqueous dispersion of a polyester having a glass transition temperature of 20° C., UW1527F (Ube Industries) as an aqueous dispersion of a thermosetting polyurethane, glycerol, triethylene glycol monobutyl ether, triethanolamine, OLFINE E1010 (Nissin Chemical Industry) as a surfactant, and purified water according to predetermined proportions. The resulting mixture was slurried by stirring at 3000 rpm with a high-shear mixer (Silverson).

The resulting slurry was stirred using a bead mill (LMZ015, Ashizawa Finetech) with 0.5-mm glass beads under water-cooled conditions to disperse the materials therein. Then the glass beads were removed, giving an ink jet ink as an aqueous ink jet composition.

The acid value of the polyester in the MD-1480 was 3 KOH mg/g. The hydroxyl value of the polyester was 6 KOH mg/g, and the number-average molecular weight of the polyester was 15×10³.

### Examples 2 to 13

An ink jet ink was produced as in Example 1 except that the formula was as in Table 1.

### Comparative Examples 1 to 5

An ink jet ink was produced as in Example 1 except that no urethane resin was used and the proportions of ingredients were adjusted according to the formula given in Table 1.

### Comparative Example 6

An ink jet ink was produced as in Example 1 except that no polyester was used and the proportions of ingredients were adjusted according to the formula given in Table 1.

### Comparative Example 7

An ink jet ink was produced as in Example 1 except that no polyester or urethane resin was used and the proportions of ingredients were adjusted according to the formula given in Table 1.

The makeup of the ink jet inks of Examples and Comparative Examples is summarized in Table 1. In the table, “%” means “% by mass.” C.I. Disperse Red 364 is represented by “DR364,” C.I. Disperse Yellow 232 is represented by “DY232,” C.I. Disperse Yellow 54 is represented by “DY54,” C.I. Disperse Red 60 is represented by “DR60,” C.I. Disperse Blue 360 is represented by “DB360,” C.I. Disperse Blue 359 is represented by “DB359,” C.I. Disperse Orange 25 is represented by “DO25,” C.I. Disperse Orange 60 is represented by “DO60,” polyester is represented by “PEs,” a urethane resin is represented by “PU,” the solids content of EPOCROS K2010E (emulsion of an oxazoline-containing polymer; glass transition temperature, -50° C.) is represented by “K2010E,” the solids content of EPOCROS WS-300 (aqueous solution of an oxazoline-containing polymer) is represented by “WS-300,” glycerol is represented by “Gly,” triethylene glycol monobutyl ether is represented by “TEGBE,” triethanolamine is represented by “TEA,” and OLFINE E1010 (Nissin Chemical Industry) is represented by “E1010.” Furthermore, in the table, “PEs with a Tg of 20° C.” represents a polyester having a glass transition temperature of 20° C. as the solids content of Vylonal MD-1480 (Toyobo) as an aqueous dispersion of a thermosetting polyester, and “PEs with a Tg of 70° C.” represents a polyester having a glass transition temperature of 70° C. as the solids content of Vylonal MD-2000 (Toyobo) as an aqueous dispersion of a thermosetting polyester. The ink jet inks of all Examples had a surface tension of 25 mN/m or more and 35 mN/m or less. The surface tension was measured by the Wilhelmy method at 25° C. using a surface tensiometer (Kyowa Interface Science CBVP-7). The ink jet inks of all Examples had a viscosity of 4 mPa·s or more and 10 mPa·s or less. The viscosity was measured using MCR-300 rheometer (Physica). With this rheometer, the shear rate was increased from 10 [s¹] to 1000 [s¹] at 25° C., and the viscosity was read at a shear rate of 200. In all aqueous ink jet compositions, the polyester was in particulate form, and the average particle diameter of the polyester was 60 nm or more and 200 nm or less. For all ink jet inks of Examples, 4.0≤X_{E}/X_{D}≤300, 2.0≤X_{U}/X_{D}≤150, and 1.5≤X_{E}/X_{U}≤5.0, where X_{D} is the dye content of the aqueous ink jet composition (% by mass), X_{E} is the polyester content of the aqueous ink jet composition (% by mass), and X_{U} is the urethane resin content of the aqueous ink jet composition (% by mass).

TABLE 1

| | Specific dye(s) | | | | | | | | PEs | | |
|---|---|---|---|---|---|---|---|---|---|---|---|
| | DY | DR | DB | DB | DO | DO | DR | DY | PEs with a | PEs with a | |
| | 54 | 60 | 360 | 359 | 25 | 60 | 364 | 232 | Tg of 20° C. | Tg of 70° C. | PU |
| | [%] | [%] | [%] | [%] | [%] | [%] | [%] | [%] | [%] | [%] | [%] |
| Example 1 | 0.5 | 0 | 0 | 0 | 0 | 0 | 0 | 0 | 2 | 0 | 1 |
| Example 2 | 0.5 | 0 | 0 | 0 | 0 | 0 | 0 | 0 | 15 | 0 | 5 |
| Example 3 | 0.5 | 0 | 0 | 0 | 0 | 0 | 0 | 0 | 0 | 20 | 10 |
| Example 4 | 0.5 | 0 | 0 | 0 | 0 | 0 | 0 | 0 | 10 | 10 | 10 |
| Example 5 | 0.5 | 0 | 0 | 0 | 0 | 0 | 0 | 0 | 10 | 10 | 5 |
| Example 6 | 0 | 0.1 | 0 | 0 | 0 | 0 | 0 | 0 | 20 | 0 | 5 |
| Example 7 | 0 | 0 | 3 | 0 | 0 | 0 | 0 | 0 | 30 | 0 | 6 |
| Example 8 | 0 | 0 | 0 | 0.1 | 0 | 0 | 0 | 0 | 0 | 30 | 15 |
| Example 9 | 0 | 0 | 0 | 0 | 0.5 | 0 | 0 | 0 | 0 | 10 | 20 |
| Example 10 | 0 | 0 | 0 | 0 | 0 | 0.1 | 0 | 0 | 0 | 10 | 2 |
| Example 11 | 0 | 0 | 0 | 0 | 0 | 0 | 0.2 | 0 | 3 | 0 | 2 |
| Example 12 | 0 | 0 | 0 | 0 | 0 | 0 | 0 | 0.2 | 0 | 3 | 2 |
| Example 13 | 0.3 | 0 | 0.2 | 0 | 0 | 0 | 0 | 0 | 0 | 20 | 10 |
| Comparative | 0.5 | 0 | 0 | 0 | 0 | 0 | 0 | 0 | 1 | 0 | 0 |
| Example 1 | | | | | | | | | | | |
| Comparative | 0.05 | 0 | 0 | 0 | 0 | 0 | 0 | 0 | 20 | 0 | 0 |
| Example 2 | | | | | | | | | | | |
| Comparative | 0.5 | 0 | 0 | 0 | 0 | 0 | 0 | 0 | 0 | 5 | 0.5 |
| Example 3 | | | | | | | | | | | |
| Comparative | 0.05 | 0 | 0 | 0 | 0 | 0 | 0 | 0 | 0 | 16 | 8 |
| Example 4 | | | | | | | | | | | |
| Comparative | 0.5 | 0 | 0 | 0 | 0 | 0 | 0 | 0 | 5 | 0 | 5 |
| Example 5 | | | | | | | | | | | |
| Comparative | 0.2 | 0 | 0 | 0 | 0 | 0 | 0 | 0 | 12 | 0 | 2 |
| Example 6 | | | | | | | | | | | |
| Comparative | 0.5 | 0 | 0 | 0 | 0 | 0 | 0 | 0 | 0 | 0 | 0 |
| Example 7 | | | | | | | | | | | |

| | Oxazoline- | | | | | | | | | |
|---|---|---|---|---|---|---|---|---|---|---|
| | containing | | | | | | | | | |
| | polymer | | | | | | | | | |
| | K2101 | WS-300 | Gly | TEGBE | TEA | E1010 | Water | | | |
| | [%] | [%] | [%] | [%] | [%] | [%] | [%] | X_{E}/X_{D} | X_{U}/X_{D} | X_{E}/X_{U} |
| Example 1 | 0 | 0 | 10 | 3 | 1 | 0.5 | 82 | 5 | 2 | 2 |
| Example 2 | 0 | 1 | 10 | 3 | 1 | 0.5 | 64 | 30 | 10 | 3 |
| Example 3 | 0 | 1 | 10 | 3 | 1 | 0.5 | 54 | 40 | 20 | 2 |
| Example 4 | 1 | 0 | 10 | 3 | 1 | 0.5 | 54 | 40 | 20 | 2 |
| Example 5 | 1 | 0 | 10 | 3 | 1 | 0.5 | 59 | 40 | 10 | 4 |
| Example 6 | 0 | 1 | 10 | 3 | 1 | 0.5 | 59.4 | 200 | 50 | 4 |
| Example 7 | 0 | 1 | 10 | 3 | 1 | 0.5 | 45.5 | 10 | 2 | 5 |
| Example 8 | 1 | 0 | 10 | 3 | 1 | 0.5 | 39.4 | 150 | 150 | 2 |
| Example 9 | 1 | 0 | 10 | 3 | 1 | 0.5 | 54 | 40 | 40 | 0.5 |
| Example 10 | 0 | 1 | 10 | 3 | 1 | 0.5 | 72.4 | 20 | 20 | 5 |
| Example 11 | 0 | 1 | 10 | 3 | 1 | 0.5 | 79.3 | 10 | 10 | 1.5 |
| Example 12 | 2 | 0 | 10 | 3 | 1 | 0.5 | 78.3 | 10 | 10 | 1.5 |
| Example 13 | 1 | 0 | 10 | 3 | 1 | 0.5 | 54 | 40 | 20 | 2 |
| Comparative | 0 | 0 | 10 | 3 | 1 | 0.5 | 83 | 2 | 0 | — |
| Example 1 | | | | | | | | | | |
| Comparative | 0 | 0 | 10 | 3 | 1 | 0.5 | 70 | 400 | 0 | — |
| Example 2 | | | | | | | | | | |
| Comparative | 0 | 0 | 10 | 3 | 1 | 0.5 | 60 | 40 | 1 | 10 |
| Example 3 | | | | | | | | | | |
| Comparative | 0 | 0 | 10 | 3 | 1 | 0.5 | 75 | 320 | 160 | 2 |
| Example 4 | | | | | | | | | | |
| Comparative | 0 | 0 | 10 | 3 | 1 | 0.5 | 75 | 10 | 10 | 1 |
| Example 5 | | | | | | | | | | |
| Comparative | 0 | 0 | 10 | 3 | 1 | 0.5 | 80 | 60 | 10 | 6 |
| Example 6 | | | | | | | | | | |
| Comparative | 0 | 0 | 10 | 3 | 1 | 0.5 | 85 | 0 | 0 | — |
| Example 7 | | | | | | | | | | |

### 2. Testing

### 2-1 Storage Properties of the Ink Jet Ink

Each ink jet ink of Examples and Comparative Examples as freshly prepared was packed in a predetermined ink pack, stored for 7 days under heated conditions at 70° C., and subjected to viscosity measurement. The percentage change in viscosity after the storage under heated conditions was determined, and the storage properties of the ink jet ink were graded according to the criteria below. Smaller percentage changes in viscosity mean better storage properties of the ink jet ink. An ink was considered good if the grade was B or better. The viscosity of the ink jet inks was measured using MCR-300 rheometer (Physica). With this rheometer, the shear rate was increased from 10 [s⁻¹] to 1000 [s⁻¹] at 25° C., and the viscosity was read at a shear rate of 200.

A: The percentage change in viscosity is less than 2%.

B: The percentage change in viscosity is 2% or more and less than 5%.

C: The percentage change in viscosity is 5% or more and less than 7%.

D: The percentage change in viscosity is 7% or more and less than 10%.

E: The percentage change in viscosity is 10% or more.

### 2-2 Stability of the Ink Jet Ink Upon Ejection

Each ink jet ink of Examples and Comparative Examples as freshly prepared was packed in a predetermined ink container and stored for 1 day under 23° C. conditions.

Then the container was attached to PX-M860F recording apparatus (Seiko Epson), and the ink jet ink was ejected to attach a solid pattern to sheets of grade P plain paper (Fuji Xerox) as a recording medium. The recording resolution was 600 dpi.

Thirty sheets of the recording medium with a recorded solid pattern thereon were checked for nonejecting nozzles, i.e., nozzles that failed to eject the ink, and stability upon ejection was graded according to the criteria below. An ink was considered good if the grade was B or better.

A: The number of nonejecting nozzles was 0.

B: The number of nonejecting nozzles was 1 or more and 3 or less.

C: The number of nonejecting nozzles was 4 or more and 10 or less.

D: The number of nonejecting nozzles was 11 or more and 20 or less.

E: The number of nonejecting nozzles was 21 or more.

### 2-3 Color Strength

Each ink jet ink of Examples and Comparative Examples as freshly prepared was ejected from PX-M860F recording apparatus (Seiko Epson) to draw a predetermined pattern on a piece of cotton fabric as a recording medium.

Then the side of the recording medium onto which the ink jet ink had been attached was heated at 160° C. for 60 seconds using an iron as a heater, completing a recording.

The resulting recordings were graded for color strength. Specifically, in the production of each recording, chromaticity was measured between the attachment of ink jet ink and heating. The finished recording was also subjected to the measurement of chromaticity. The points of measurement were a point in the portion of the recording medium to which the ink jet ink had been attached and the same point of the finished recording, and the measuring instrument was i1 (X-rite). The results were used to determine the percentage increase after heating in saturation as measured in the L*a*b* color space (square root of (a*²+b*²)), and the optical density (OD) was also determined at a point of the recording to which the ink jet ink had been attached. Then color strength was graded according to the criteria below. Greater percentage increases in saturation and higher ODs mean better color strength. A recording was considered good if the grade was B or better.

A: The percentage increase in saturation is 50% or more, and the OD is 0.5 or more.

B: The percentage increase in saturation is 30% or more and less than 50%, and the OD is 0.5 or more.

C: The percentage increase in saturation is 15% or more and less than 30%, and the OD is 0.5 or more.

D: The percentage increase in saturation is 0% or more and less than 15%, and the OD is 0.5 or more.

E: Saturation is lower than before heating, or the OD is less than 0.5.

Then the same color strength test was repeated with different recording media: a piece of polyester fiber fabric, a piece of mixed fabric of polyester fiber and cotton fiber, a piece of silk fabric, a piece of polyurethane fiber fabric, a piece of acrylic fiber fabric, and a piece of polyamide fiber fabric.

### 2-4 Fixation

Of the recordings of Examples and Comparative Examples produced in Section 2-3, those that were made using a piece of cotton fabric as a recording medium were washed with a laundry detergent (Lion TOP Clear Liquid) and warm water at 40° C. in a home washing machine (Toshiba Lifestyle Products & Services TW-Z9500L front-loader washing and drying machine) set to its standard mode. The percentage decrease in the OD of the print after washing was determined, and fixation was graded according to the criteria below. Smaller percentage decreases in OD mean better fixation of the print formed by the ink jet ink to the recording medium. A recording was considered good if the grade was B or better.

A: The percentage decrease in OD is less than 3%.

B: The percentage decrease in OD is 3% or more and less than 10%.

C: The percentage decrease in OD is 10% or more and less than 30%.

D: The percentage decrease in OD is 30% or more and less than 50%.

E: The percentage decrease in OD is 50% or more.

### 2-5 Feel and Texture

The recordings washed in Section 2-4 were visually inspected, for example for creases, and graded according to the criteria below. Fewer creases or similar lines mean better feel and texture. A recording was considered good if the grade was B or better.

A: The washed recording has no fold or crease.

B: The washed recording has few folds or creases.

C: The washed recording has folds, but with few creases.

D: The washed recording is slightly creased.

E: The washed recording is deeply creased.

The results are summarized in Table 2.

TABLE 2

| | Storage | Stability of | Color strength | | |
|---|---|---|---|---|---|
| | properties of | the ink jet ink | | Polyester | Polyester-cotton |
| | the ink jet ink | upon ejection | Cotton fabric | fiber fabric | mixed fabric |
| Example 1 | A | A | B | A | A |
| Example 2 | A | B | A | A | A |
| Example 3 | A | B | A | A | A |
| Example 4 | B | A | A | A | A |
| Example 5 | A | A | A | A | A |
| Example 6 | B | A | A | A | A |
| Example 7 | B | B | A | A | A |
| Example 8 | A | B | A | A | A |
| Example 9 | B | B | B | A | A |
| Example 10 | A | A | B | A | A |
| Example 11 | A | A | B | A | A |
| Example 12 | A | A | B | A | A |
| Example 13 | A | B | A | A | A |
| Comparative | E | A | E | A | D |
| Example 1 | | | | | |
| Comparative | D | A | A | A | A |
| Example 2 | | | | | |
| Comparative | B | B | D | A | D |
| Example 3 | | | | | |
| Comparative | B | A | A | A | D |
| Example 4 | | | | | |
| Comparative | A | A | D | A | D |
| Example 5 | | | | | |
| Comparative | A | A | D | A | D |
| Example 6 | | | | | |
| Comparative | A | A | E | A | E |
| Example 7 | | | | | |

| | Color strength | | | | | |
|---|---|---|---|---|---|---|
| | | Polyurethane | Acrylic fiber | Polyamide | | Feel and |
| | Silk fabric | fiber fabric | fabric | fiber fabric | Fixation | texture |
| Example 1 | B | B | B | B | B | A |
| Example 2 | A | A | A | A | A | A |
| Example 3 | A | A | A | A | A | B |
| Example 4 | A | A | A | A | A | B |
| Example 5 | A | A | A | A | A | A |
| Example 6 | A | A | A | A | A | A |
| Example 7 | A | A | A | A | A | A |
| Example 8 | A | A | A | A | A | A |
| Example 9 | B | B | B | B | A | B |
| Example 10 | B | B | B | B | A | B |
| Example 11 | B | B | B | B | A | B |
| Example 12 | B | B | B | B | B | A |
| Example 13 | A | A | A | A | B | A |
| Comparative | E | E | E | E | E | D |
| Example 1 | | | | | | |
| Comparative | A | A | A | A | B | D |
| Example 2 | | | | | | |
| Comparative | D | D | D | D | D | D |
| Example 3 | | | | | | |
| Comparative | A | A | A | A | B | E |
| Example 4 | | | | | | |
| Comparative | D | D | D | D | D | D |
| Example 5 | | | | | | |
| Comparative | D | D | D | D | D | D |
| Example 6 | | | | | | |
| Comparative | E | E | E | E | E | B |
| Example 7 | | | | | | |

As is clear from Table 2, examples of aspects of the present disclosure achieved good results. In Comparative Examples, the results were unsatisfactory.

Another set of recordings were produced in the same way but with a sheet of cellulose paper as a recording medium and tested as in Section 2-3, and the results were the same. Then recordings were produced as in Section 2-3 except that the recording medium was any of a piece of wool fabric or a piece of polyamide fiber fabric and that the recording medium with ink jet ink attached thereto was heated at 200° C. for 60 seconds. In this case, the recordings were not evaluable. With wool fabric, the recording medium scorched when heated. With polyamide fiber, the recording medium melted when heated.

What is claimed is:

1. An aqueous ink jet composition comprising:
water;
a dye composed of at least one of sublimation dyes or at least one of disperse dyes;
polyester; and
a urethane resin.

2. The aqueous ink jet composition according to claim 1, further comprising an oxazoline-containing polymer.

3. The aqueous ink jet composition according to claim 1, wherein an amount of the dye in the aqueous ink jet composition is 0.1% by mass or more and 3.0% by mass or less.

4. The aqueous ink jet composition according to claim 1, wherein an amount of the polyester in the aqueous ink jet composition is 5% by mass or more and 30% by mass or less.

5. The aqueous ink jet composition according to claim 1, wherein an amount of the urethane resin in the aqueous ink jet composition is 2.5% by mass or more and 15% by mass or less.

6. The aqueous ink jet composition according to claim 1, wherein 4.0≤X_{E}/X_{D}≤300, where X_{D} is an amount of the dye in the aqueous ink jet composition in % by mass, and X_{E} is the amount of the polyester in the aqueous ink jet composition in % by mass.

7. The aqueous ink jet composition according to claim 1, wherein 2.0≤X_{U}/X_{D}≤150, where X_{D} is an amount of the dye in the aqueous ink jet composition in % by mass, and X_{U} is an amount of the urethane resin in the aqueous ink jet composition in % by mass.

8. The aqueous ink jet composition according to claim 1, wherein 1.5≤X_{E}/X_{U}≤5.0, where X_{E} is an amount of the polyester in the aqueous ink jet composition in % by mass, and X_{U} is an amount of the urethane resin in the aqueous ink jet composition in % by mass.

9. The aqueous ink jet composition according to claim 1, wherein a glass transition temperature of the polyester is 0° C. or more and 90° C. or less.

10. The aqueous ink jet composition according to claim 1, wherein the dye is one or two or more selected from the group consisting of C.I. Disperse Yellow 54, C.I. Disperse Red 60, C.I. Disperse Blue 360, C.I. Disperse Blue 359, C.I. Disperse Orange 25, C.I. Disperse Orange 60, C.I. Disperse Red 364, and C.I. Disperse Yellow 232.

11. A method for producing a recording, the method comprising:
an attachment step, in which an aqueous ink jet composition according to claim 1 is ejected by ink jet technology and attached to a recording medium; and
a heating step, in which the recording medium with the aqueous ink jet composition attached thereto is heated.

12. The method according to claim 11 for producing a recording, wherein the recording medium is a piece of fabric.

13. The method according to claim 11 for producing a recording, wherein the recording medium is made of at least one material including one or two or more selected from the group consisting of silk, wool, cellulose, acrylic fiber, polyurethane, and polyamide.

14. The method according to claim 11 for producing a recording, wherein the recording medium is made of materials including polyester and one or two or more selected from the group consisting of cotton, silk, polyamide, acrylic fiber, and polyurethane.

15. The method according to claim 11 for producing a recording, wherein a temperature at which the recording medium is heated in the heating step is 100° C. or more and 160° C. or less.
